(19) United States
(12) Patent Application Publication
(10) Pub. No.: US 2010/0241664 A1
(43) Pub. Date: Sep. 23, 2010

(54) SMART WEB PAGES PROVISIONING SYSTEM AND METHOD FOR MOBILE DEVICES

(75) Inventors: Lisa A. LeVasseur, San Diego, CA (US); Scevhur Y. Pike, Irvine, CA (US)

Correspondence Address: SCULLY SCOTT MURPHY & PRESSER, PC, 400 GARDEN CITY PLAZA, SUITE 300, GARDEN CITY, NY, 11530, US

(73) Assignee: DIALPLUS, INC., San Diego, CA (US)

(21) Appl. No.: 12/741,678

(22) PCT Filed: Mar. 18, 2008
(86) PCT No.: PCT/US08/03529

§ 371 Date: May 6, 2010

Related U.S. Application Data
(60) Provisional application No. 60/986,205, filed on Nov. 7, 2007.

(51) Int. Cl. G06F 17/30; G06F 3/048; G06F 15/16

(52) U.S. Cl. 707/779; 715/835; 709/228; 707/E17.014

(57) ABSTRACT

A system, method and computer program product for automatically creating enhanced content for communication devices when a voic call is established between two or more communication devices The method includes providing, to a server device in association with the communications network, the called party phone number and generating a data structure associated with the phone number, the data structure including a search criteria used to enhance information content about the called and calling party to be provided to each communication device The server device initiates, via a search tool, a web-based search for enhanced information content according to the search criteria provided by the data structure and generates, in response to the call, a web page including the enhanced content The web page including the enhanced content is communicated to each communication device

### BACKGROUND OF THE INVENTION

Current mobile device technologies do not provide for smart visually-based content to be received at the mobile device that is contextual to the user's situation and tailored to the individual needs of the calling or called party while simultaneously carrying on voice communications between the called and calling party devices, or not.

It would be highly desirable to provide a communications system and back-end infrastructure enabling provision of outbound information (from a caller) that includes dynamically generated or user-defined personal information; and also to enable provision of inbound information (to a caller) that includes dynamically generated or user-defined adaptive “smart” content.

### SUMMARY OF THE INVENTION

The present invention relates generally to communications systems such as for mobile devices generally, as well as connected computing devices that support person-to-person communication, such as PCs, and to provisioning of SmartResults™ web pages for communication devices that comprise visual information that is context based and enhances the user communications experience while a voice conversation is taking place, or not.

Particularly, a technology and methodology for creating enhanced voice communication services for communication devices is provided that enables voice calls with simultaneous, dynamic, relevant visual information. This “voice-plus” technology is part of an intelligent web-based service for mobile devices and other communications devices and provides an enhanced communications modality that can be implemented in a variety of communication device technology platforms and executing application environments. Such enhanced communications modality includes the provision of visual information via a multimedia communications path and may include content that is otherwise referred to herein as “SmartResults™” for a mobile device, the SmartResults™ including relevant, context-based information regarding a called and/or calling party.

That is, according to the invention, a variety of SmartResults™ “Templates” may be implemented that can be populated with web-based content via semantic web/tagging technology. The resulting SmartResults™ web page may be downloaded to a mobile device and displayed via an opened browser or other rendering application.

In one aspect of the invention, there is provided a system, method and computer program product whereby a calling party enters a telephone number into a phone [e.g., implementing a dialer application, or using the native dialer application] and after the call is established, the calling party starts receiving relevant visual information about the called party (embedded in SmartResults™), on their mobile browser or other rendering application while speaking to the called party. This system also allows the option of not connecting the audio part of the call at all, but just entering the number, and selecting a soft button option of “GetInfo” (e.g.), which will just open the rendering application, e.g., a browser or other rendering application and start retrieving the appropriate SmartResults™. This system also supports the automatic sending of calling party visual multimedia information to the called party [e.g., by opening the called party's browser or other rendering application and displaying the calling party's selected SmartResults™]. The bottom line here is that phone numbers map to dynamically created URLs, and there is a bidirectional exchange of visual information either while on a voice call, or just by dialing a number from a dialer app.

A further aspect of the invention deals with the creation of SmartResults™: a system that automatically creates SmartResults™ to be displayed on mobile devices. The content of SmartResults™ will be created by populating Page Templates which will vary and be designed based on venue/enterprise/individual type and user behavior learning. The system then retrieves tagged content from existing web sites to populate the SmartResults™. This will be accomplished via Semantic Web tagging technologies and machine-to-machine communication.

According to a yet further aspect of the invention, there is provided a system and method that takes as input—in addition to dialed digits—mobile device contextual information including but not limited to geographic location, presence status, time of day, implicitly learned patterns, and spoken word speech recognition to produce even “smarter” SmartResults™. For example, if a user calls a store near closing time, it is predicted that they are likely calling to confirm hours of operation or location/directions. Thus, the resulting SmartResults™ web page will prominently feature hours of operation and a visual map/directions to the store from where you are now. Another example is if a user is speaking to an interactive voice response system; the system “hears” that the user has said “Check Balance” and automatically displays the info on the SmartResults™ web page [as well as providing it via the IVR].

According to a further aspect of the invention, there is provided a system that allows the calling or called party, such as customer service agents, to immediately push and receive visual information to/from a caller while simultaneously speaking to the caller. The information that is being pushed between two parties can be automatically generated based on mobile device contextual information or generated by either the calling or called party. Scenario: A user calls a hotel and asks for information about a specific ballroom; while on the call, the hotel agent is able to push photos of the desired ballroom to the caller.

As a further aspect of the invention, third party advertisements and services or applications can be integrated into the SmartResults™ web page. Advertisements may be banners, text-based or graphically-based. Services and applications can be represented by interactive visual elements that the user may “click to launch”.

### BRIEF DESCRIPTION OF THE DRAWINGS

The objects, features and advantages of the present invention will become apparent to one skilled in the art, in view of the following detailed description taken in combination with the attached drawings, in which:

FIG. 1 depicts a general block diagram illustrating an HSPA communications environment 10 in which the present invention can be employed;

FIG. 2 is an illustration of a WiMax or other all IP-core type of communications environment in which the present invention can be employed;

FIG. 3A is an illustration of the relevant device client software architecture and execution environment on a VoIP capable communication device;

FIG. 3B is an illustration of the relevant device client software architecture and execution environment on a BREW-capable communication device;

FIG. 3C is an illustration of the relevant device client software architecture and execution environment on a J2ME-capable communication device;

FIG. 3D is an illustration of the relevant device client software architecture and execution environment on a Windows Mobile communication device;

FIG. 4A is an illustration of the basic, high level communication between the communication device software clients and the backend server;

FIG. 4B is an illustration of the high level communication between the communication device software clients and the backend server, wherein advanced contextual information is provided by the communication device software client;

FIG. 5A is an illustration of the software logic flow of a call when it is first placed to/from a business entity. Logic is shown for both the communication device software client and the backend server;

FIG. 6 is an illustration of the Smart Search String;

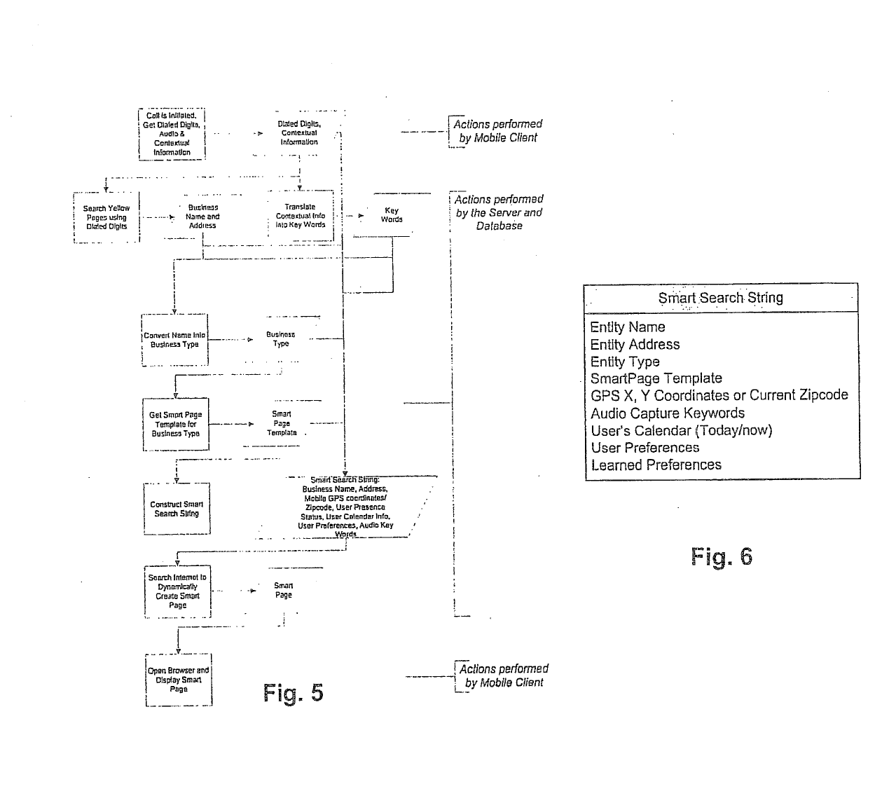

FIG. 5B is an illustration of the software logic flow of a call when it is first placed to/from a social contact. Logic is shown for both the communication device software client and the backend server;

FIG. 7 is an illustration of the software logic flow of updating SmartResults™ in the midst of an existing call;

FIG. 8 is an illustration of an example SmartResults™ session for a call to a Customer Care/Interactive Voice Response (IVR) system;

FIG. 9 provides an illustration of the SmartResults™ template for a business of type, “Hotel”; it also provides an illustration of an example SmartResults™ session for a call to a Hotel type of business; and,

FIG. 10 provides an illustration of the SmartResults™ session for a call to a social contact, in the “Friend” category.

### DETAILED DESCRIPTION OF THE PREFERRED EMBODIMENT

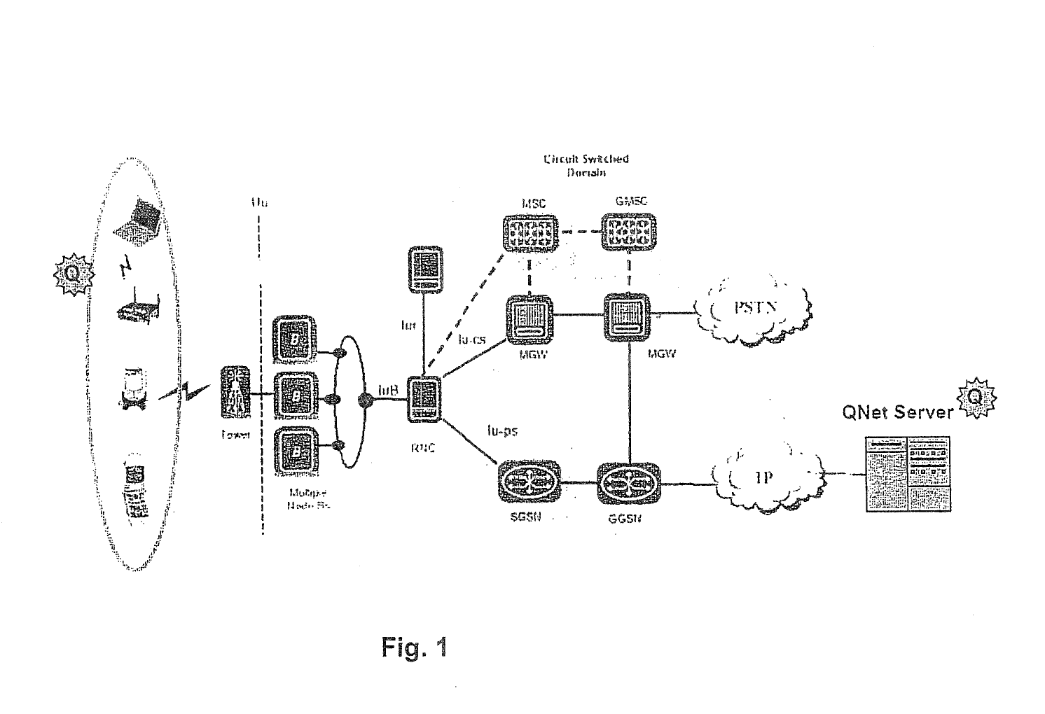

FIG. 1 depicts a general block diagram illustrating the communications environment 10 in which the present invention is employed. As shown in FIG. 1, there is depicted for illustrative and non-limiting purposes the types of mobile or fixed stations 15 that may be used by the calling or called party including a mobile phone, a mobile computing device or a PDA. For example, the calling party's client device is any mobile computing device including but not limited to: cell phones, mobile phones, smart phones, iPhones, VoIP or SIP phones, Personal Digital Assistant (PDA's) and other wireless or mobile or other fixed (connected) devices such as laptops, Ultra-Mobile PCs (UMPCs), PCs, cable/set-top boxes, etc. Such mobile devices may include an operating system and application executing environments such as typically implemented on current mobile handset devices such as Windows Mobile, Symbian, Linux, Java, BREW, native, etc. The mobile device of the calling party implements a mobile browser or other rendering application. The communications device at the called party also includes an Internet browser or other rendering application.

Additionally, a QNet client (agent) 99 is added to each of those types of mobile computing devices 15. It is understood that such client may be a downloaded/preloaded application, or may be implemented as a purely browser or other rendering application based implementation.

Each mobile device communicates over a wireless and land-line networks including packet based network and POTS for routing of the traditional voice call. In one example embodiment, FIG. 1 depicts a Universal Mobile Telecommunications System (UMTS) network architecture -one of the so-called third-generation 3G cell phone technologies. Currently, the most common form uses W-CDMA as the underlying air interface. Within this UMTS standard network is the addition of the QNet system that impacts the wireless cellular network, particularly, the addition of an application server, QNet Server 199 in the packet data part of the network.

In the architecture depicted in FIG. 1, mobiles communicate over the UMTS communication network where calls are received by one or more communications (e.g., cell phone) towers 20 where any voice and data associated with a call are received, routed and subsequently communicated via different functional Mobile Switching Center entities such as an MSC Server, a Gateway MSC Server or like switching servers 30 for eventual communication over the PSTN 50 to a called party 75. Thus, this portion of the infrastructure is typically implemented for establishing a voice communications path between the calling and called parties. However, the infrastructure provides additional interfaces, e.g., signal paths are provided between the MSC Server, GMSC Server to an IP network 70 via a Serving GPRS Support Node (SGSN) and/or Gateway GPRS Support Node (GGSN) devices 60, for eventual receipt by a server device 199, herein referred to as the QNet Server, that implements the “SmartResults™” functionality in accordance with the present invention. The addition of the Qnet server is a typical data service—a client and server based architecture utilizing the HTTP protocol. A web-based terminal 198 is used to configure, create and edit an individual's personal SmartResults™ web page. The web-based terminal 198 additionally enables QNet users to push visual information to each other via SmartResults™.

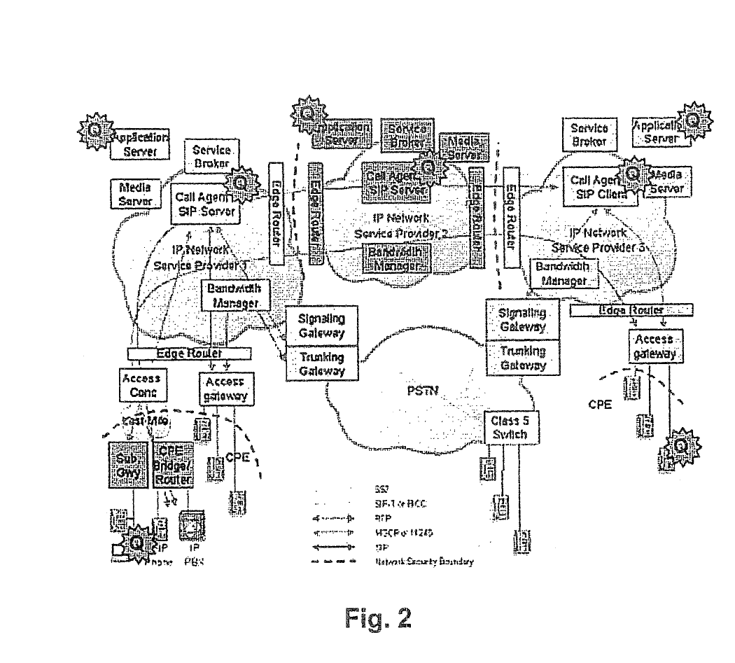

FIG. 2 depicts a general block diagram illustrating additional configurations of the communications environment, an all-IP network, for providing “SmartResults™” functionality for VoIP client implementations. As shown in FIG. 2, there is depicted for illustrative and non-limiting purposes more detail concerning the back-end infrastructure and types of multi-media communications paths that may be established in the provisioning of “SmartResults™” to the calling or called party implementing a fixed or mobile VoIP-connected computing device. FIG. 2 depicts a WiMax (WiMAX broadband wireless standard for both fixed and mobile deployments) or IMS (IP Multimedia Subsystem) implementations, for example. In this scenario, there is the QNet Server, the QNet Console web-service 197 that allows QNet users to configure, create and edit individual SmartResults™, and the QNet clients (in this example, VoIP based downloadable/preloaded apps, or browser or other rendering application based as described herein above). In addition, this scenario may require the need to provide a Call Agent SIP Server or a software extension onto the SIP Server in order to route information to the QNet server.

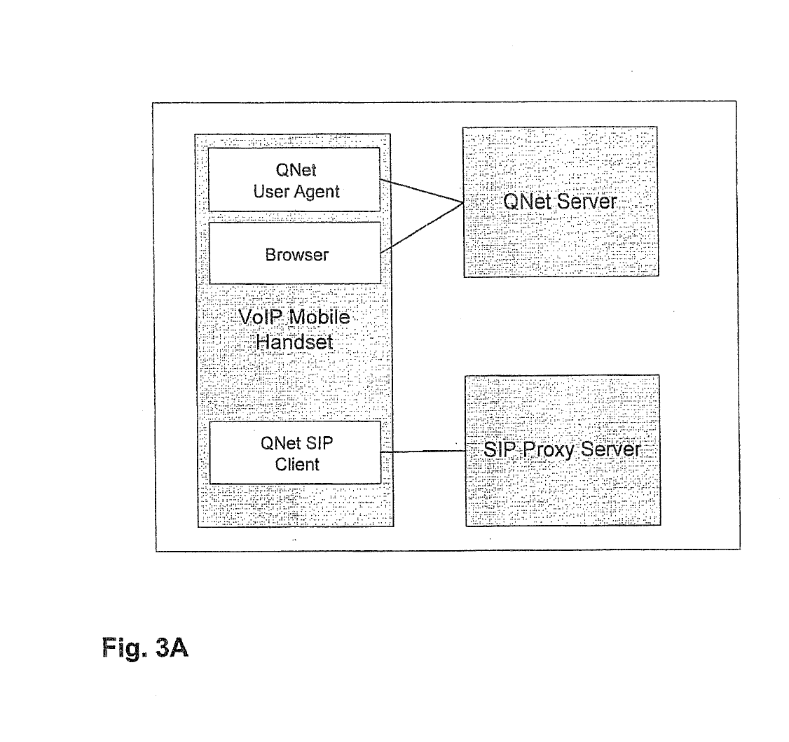

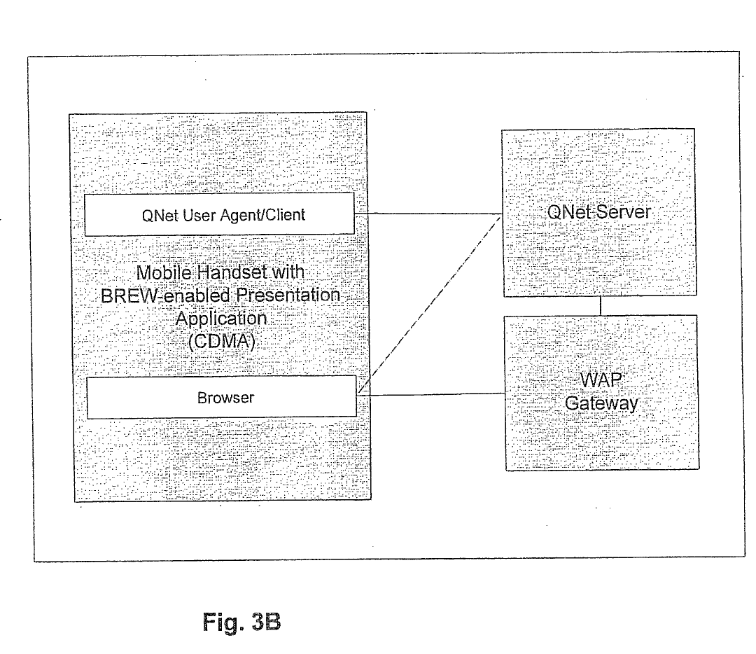

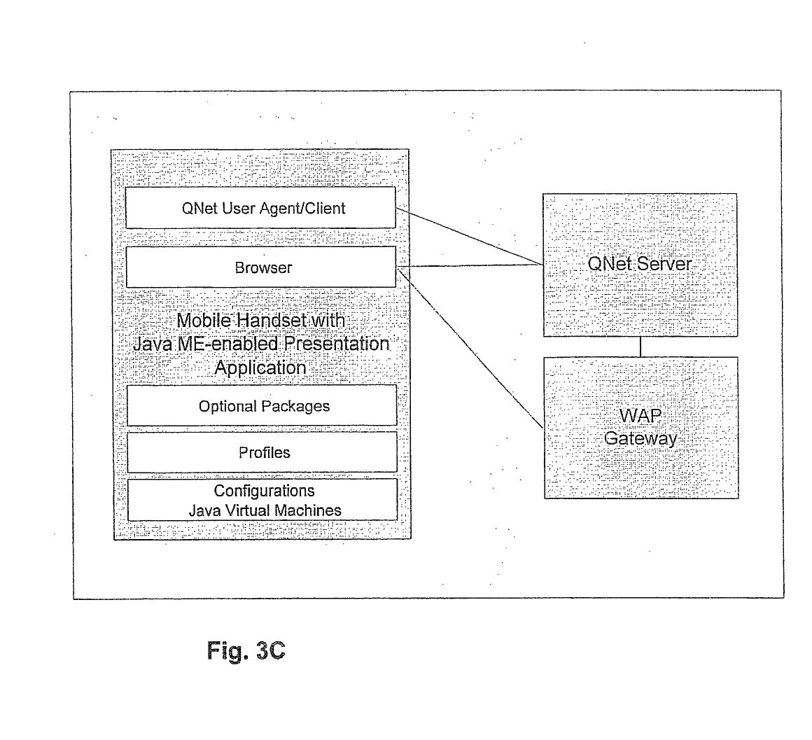

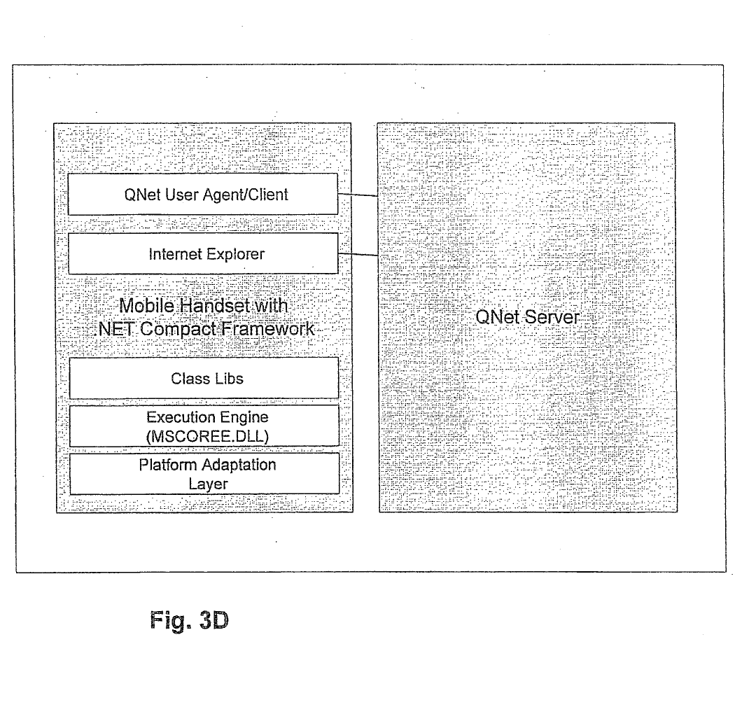

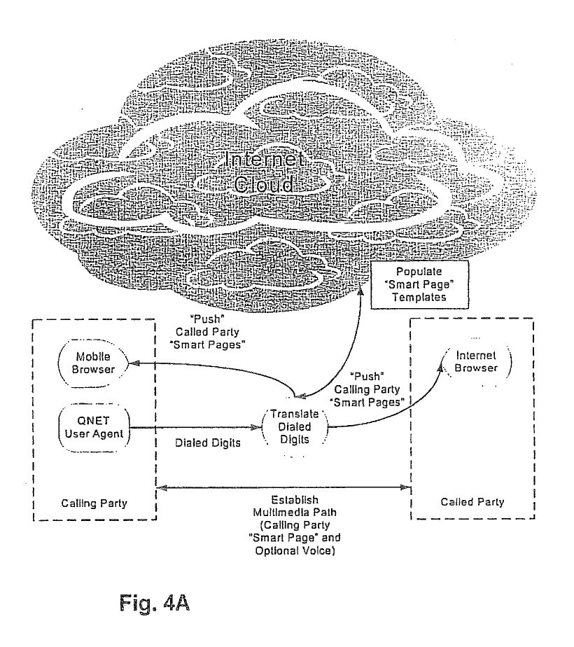

FIG. 3A depicts a conceptual call system diagram illustrating a base configuration for a first embodiment mobile device comprising a VoIP mobile handset 15a configured according to the present invention. As shown in FIG. 3A, a VoIP mobile handset includes a user (software) agent 99a, such as a QNet agent in the example embodiment described, and a browser software application 25a that interfaces with the Application Server 199, such as provided by an Internet Service Provider, e.g., QNet server, and like web hosting service, over an established IP-based data communications path. The VoIP mobile handset configuration further includes a SIP or other session control client 22, e.g., a QNet SIP, that interfaces with a SIP Proxy Server device 80.

FIG. 3A particularly depicts a more detailed device client software architecture and execution environment for a VoIP-enabled device, including a browser or other rendering application. More particularly, if the user selects Call [to make a call], the client 22 will communicate with a SIP Server 80 to initiate a VoIP call and then perform the functions 1-3 described in greater detail below. Key to this scenario is the functionality depicted at the application server 199, e.g., QNet and like web hosting server, for performing the mapping translation based on the dialed digits received and which are used to initiate the back-end's search engine's discovery of URLs associated with web-sites having content relevant to information provided in a search template. This data and visual content resulting from the Internet search may populate the template and be downloaded (pushed) to the user client device 15a as a formatted “SmartResults™”. It is understood that, at the initiation of the called party, web pages alternately may be pushed to the calling party's VoIP-enabled mobile device.

FIG. 3B depicts the device client software architecture and execution environment for a BREW-enabled device. As shown in FIG. 3B, the BREW-enabled mobile handset 15b includes the QNet user (software) client 99b and a browser or other rendering application (software application) 25b that interface with the QNet Server 199 over an established data communications path. The BREW-enabled mobile handset browser or software application client may further interface with a WAP gateway device 85 for communication with the QNet Server (WAP browser scenario) or it may communicate directly to the QNet server (HTML browser scenario), or it may communicate to another type of browser proxy (not shown). The architecture can vary depending on the carrier's implementation.

Key to the scenario depicted in FIG. 3B (and FIG. 3C below) is the functionality depicted at the QNet or like ISP server 199 for performing the mapping translation based on the dialed digits of the called party received from the calling party's device that is used to initiate the back-end's search engine's discovery of URLs associated with web-sites having content relevant to information provided in a search template. This data and visual content resulting from the Internet search populates the “SmartResults™” template and be downloaded to the user client device as WAP or HTML formatted SmartResults™. It is understood that, at the initiation of the called party, WAP or HTML web pages alternately may be pushed to the calling party's mobile device via a WAP-based communications gateway or directly to/from the browser.

FIG. 3C depicts the device client software architecture and execution environment for a J2ME-enabled device. As shown in FIG. 3C, the JAVA-enabled device 15c includes a QNet user (software) client 99c and a browser or other software application 25c that interfaces with the QNet or like web hosting application Server 199 over an established data communications path. As per the scenario depicted in FIG. 3B, the JAVA-enabled mobile handset browser or software application client may further interface with a WAP gateway device 85 for communication with the QNet Server. Additional functionality provided for the JAVA-enabled mobile handset includes optional JAVA based native resources such as application packages, profiles and a configurable JVM 32 that are used to run native applications.

FIG. 3D depicts the mobile device client software architecture and execution environment for a Windows Mobile-enabled device. As shown in FIG. 3D, the .NET Compact Framework-enabled mobile handset 15d includes a QNet user (software) agent 99d and a browser or other software application 25d that interface with the QNet Server over an established data communications path. The .NET Compact Framework-enabled mobile handset browser client includes additional supporting functionality 42 such as Class Libraries, an Execution Engine (e.g., MSCOREE.DLL) and a platform adaptation layer.

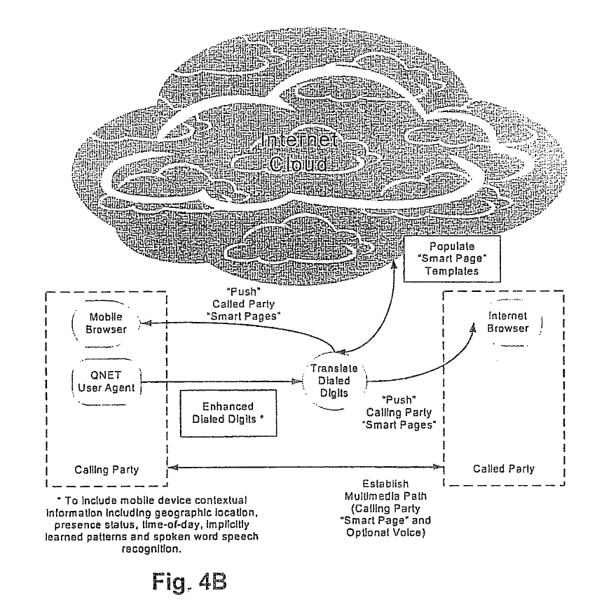

FIGS. 4A-4B generally depict conceptual call flow scenarios according to the invention and can be viewed in relation to the high-level device client software architecture diagrams provided in FIGS. 3A-3D. As shown in FIG. 4A the system includes a client device, such as a mobile client 15, associated with a calling party initiating a mobile call to a called party 75. The mobile device's user agent device 99 is a software agent executing in the mobile device operating system environment and may comprise those computer readable instructions, data structures, program modules, and application interfaces that enable user interaction with the QNet or like ISP Server via a data communications path (e.g., client/server data session) in generation of the “SmartResults™” that will be downloaded to the client device via the mobile client's browser 25 as will be described in greater detail herein. Pages will be delivered via HTTP communication protocol in standard web formats such as XML and HTML.

More particularly, as will be explained in greater detail herein, in the simple scenario shown in FIG. 4A, the dialed digits of the called party phone number are mapped to a dynamically created URL of information. That is, with the aid of intelligence built in to the QNet server infrastructure, the dialed digits 101 of the called (or calling) party are used to form a data structure that is further used at the ISP (QNet) Server to initiate generation of the enhanced visual content (“smart” web page, or other web content) to be provisioned to the calling party's device in the generation of a SmartResults™ web page.

As further shown in FIG. 4A, in the base call flow scenario depicted, a calling party initiates a call and dials digits 101 associated with the called party, which in one embodiment may be a VoIP client or a fixed land-line phone or virtually any type of callable device. The called party's digits 101 are communicated, e.g., over a mobile communications network, as dialed by the user's mobile and the data structure representing the dialed digits are eventually received at the QNet Server at an IP-based network processing node that includes a database and a visual information server back-end. More particularly, at the processing node, a service, represented by function depicted as service block 105, translates the dialed digits of the called party into a search string, from which a dynamically created SmartResults™ web page is created using a SmartResults™ Templates 110 according to functionality described herein. Particularly, dynamically created SmartResults™ are created from information harvested from the Internet using the search string. Advertisement content, such as may be provided by a 3^{rd} party advertisement service 120 and appropriate 3^{rd} party services/applications 120, are also inserted into the resulting SmartResults™ web page at this point. The SmartResults™ web page is then downloaded to the user mobile device while the voice communication is taking place between the called and calling parties. Smart pages can be automatically created or, in a further embodiment depicted in FIG. 4A, the called party can push content 150a to the calling party device over the communications path upon receiving a phone call by the calling party; or, alternately, as shown in FIG. 4A, the calling party can push content 150b to the called party device over the established data communication path.

Optionally, the provisioning of and user interaction with SmartResults™ to a calling party may occur simultaneously with the carrying on of a voice conversation between that calling party's mobile and a called party device, which may be a mobile device or a land-line device client implementing, for example, VoIP or any type of connected computing device that can be called.

Key to this scenario is the functionality depicted at the application server, e.g., QNet server, for discovering Internet-based information (e.g., that is addressed by URLs, and in the future by other things, such as RDF, or proprietary tags). That is, the QNet server performs the mapping translation based on the dialed digits of the called party received from the calling party's device that is used to initiate the back-end's search engine's discovery of URLs associated with web-sites having content relevant to information provided in a search template. This data and visual content resulting from the Internet search may populate the template 110 and be downloaded to the user client device as HTML formatted “SmartResults™”. It is understood that, at the initiation of the called party, HTML web pages alternately may be pushed to the calling party's mobile device.

FIG. 4B depicts a further conceptual flow scenario according to a further embodiment of the invention. For instance, as shown in FIG. 4B, the call flow scenario is the same as in the scenario depicted in FIG. 4A, however, contextual information 102, in addition to the dialed digits 101, is passed to the QNet Server or like Web hosting device, which are collectively used to create the search string, and ultimately populate the SmartResults™ that is eventually communicated back to the calling party's mobile device as a SmartResults™ web page via a data communications path.

More particularly, in the embodiments shown with respect to FIGS. 4A and 4B, the dialed digits of the called party are translated into a smart search string data structure that includes one or more key words used as a search template for searching out web-based content to be populated in the SmartResults™ web page. The searched out content may then be organized according to the pre-determined template and pushed to the client mobile device (of the calling party) as a SmartResults™ over the established data communications path. Alternately, as shown in FIG. 4B, the calling party can push content to the called party device over the data communications path.

The QNet client (agent) as shown in FIGS. 3A, 3B, 3C, 3D, 4A and 4B, performs the following:
1. It establishes data sessions with the application server to exchange information.
2. It “wakes up” when outgoing calls are made or incoming calls are received and passes information to the application server.
3. It launches the native browser or other rendering application on the mobile client device to a set of designated SmartResults™ [dynamically created URL].
4. The client may optionally have a Dialer user interface, wherein when the user launches the application, it will present a dialer screen interface and one or more soft keys indicating: “Call” or “GetInfo”.
   a. IF the user selects Call, the client will use natively provided APIs to launch a voice call, and then perform functions 1-3 described above.
   b. IF the user selects GetInfo, it will automatically perform functions 1-3 described above.

As further shown in FIG. 4B, in this example scenario, the dialed digits 101 are “enhanced” with additional data to include mobile device contextual information 102. Such mobile device contextual information may be used by the QNet server search infrastructure to seek out (e.g., via the Internet 70) and obtain more relevant content and mobile ads and services, based on the contextual information provided by the mobile device (e.g., calling party). Such “enhanced” dialed digit data includes mobile device contextual information including but not limited to: geographic location of the mobile (e.g., in the form of GPS coordinates), presence status, user calendar data, time-of-day, implicitly learned patterns and spoken word speech recognition capability. FIG. 4B illustrates the fact that the voice call part of the experience can be optional, and that instead, the “call” is really an exchange of SmartResults™ between the calling and the called parties.

FIG. 5A provides more detailed call flow logic and, particularly, a call flow algorithm depicting process steps 200 invoked by a caller when initiating a consumer to business (C2B) call, for example. Key to this algorithm is the functionality depicted at the application or host server, e.g., QNet server, for performing the mapping translation based on the dialed digits and any context information received from the calling device. As part of this functionality, assuming the called party is a business, the dialed digits and any contextual information are received (step 202) may be used to look-up the business name/address on-line using, for example, a reverse yellow pages look-up (step 204). Thus, a result of this mapping function is to obtain a business name and address. Further, in a dynamic parallel process, the contextual information/data (e.g., GPS coordinates) provided by the calling party is communicated to the Qnet server by a data session opened by the client on the mobile device to communicate all information to/from the server over TCP/IP packets in a defined QNet protocol. The provided contextual information/data is translated into one or more keywords suitable for searching (step 206). In one embodiment, from the contextual information provided by a calling party and the mapped business information associated with the called party, several sub-processes (step 208) are executed to convert the business name to a business type, such as “Restaurant” or “Clothing Retailer”, retrieve a SmartResults™ Template for that determined business type, and finally, to generate a “smart” search string 250. Finally, a search conducted by the QNet server, e.g., by Google or other available resources on the web, to dynamically create a SmartResults™ web page, i.e., populate a search template (step 210), e.g., with both service/applications or advertisement(s). Both the business information pertaining to the called party and the translated contextual keywords are used to form a “smart” search string at the QNet server that may include, but is not limited to: Business Name, Address, Mobile GPS coordinates/Zipcode, User Presence Status, User Calendar Info, User Preferences, Audio Key Words. After these steps are performed, further action at the mobile device includes invoking functionality for opening up the browser so a user can view the resulting SmartResults™ web page (step 212).

FIG. 5B is similar to FIG. 5A in that it depicts a more detailed call flow scenario including process steps 222-232 corresponding to process steps 202-212 in FIG. 5A. However, in difference to the example call flow scenario depicted in FIG. 5A, FIG. 5B depicts the process steps invoked by the system when making a call to an individual, instead of a place of business; e.g., a P2P scenario. In this P2P scenario, the dialed digits and any contextual information received (step 222) may be used to look-up an individual contact (native contact) on-line using, for example, a White Pages look-up service (step 224) to locate the individuals. As shown in FIG. 5B, the individuals to be contacted are categorized into Social Tiers, such that rather than converting the retrieved name/address into a business type, a “Social Tier” status is assigned and the SmartResults™ to be generated will vary depending on the Social Tier and permission settings. For example, Social Tiers may be Intimate, Friend, Acquaintance, Colleague and Stranger, for example. Thus, in one embodiment, from the contextual information provided by a calling party and the mapped individual information associated with the called party, several sub-processes (step 228) are executed to convert the individual name to a social tier, retrieve a SmartResults™ Template for that determined social type, and finally, to generate a “smart” search string 275. Finally, a search conducted by the QNet server, e.g., by Google or other available resources on the web, to dynamically create a SmartResults™ resulting web page, i.e., populate a search template (step 230), e.g., with both service/applications or advertisement(s). After these steps are performed, further action at the mobile device includes invoking functionality for opening up the browser so a user can view the SmartResults™ (step 232).

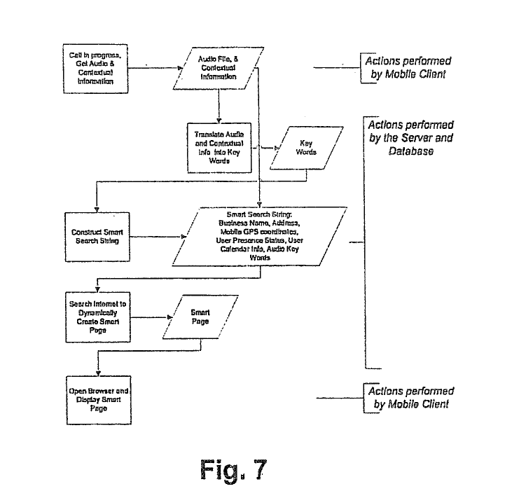

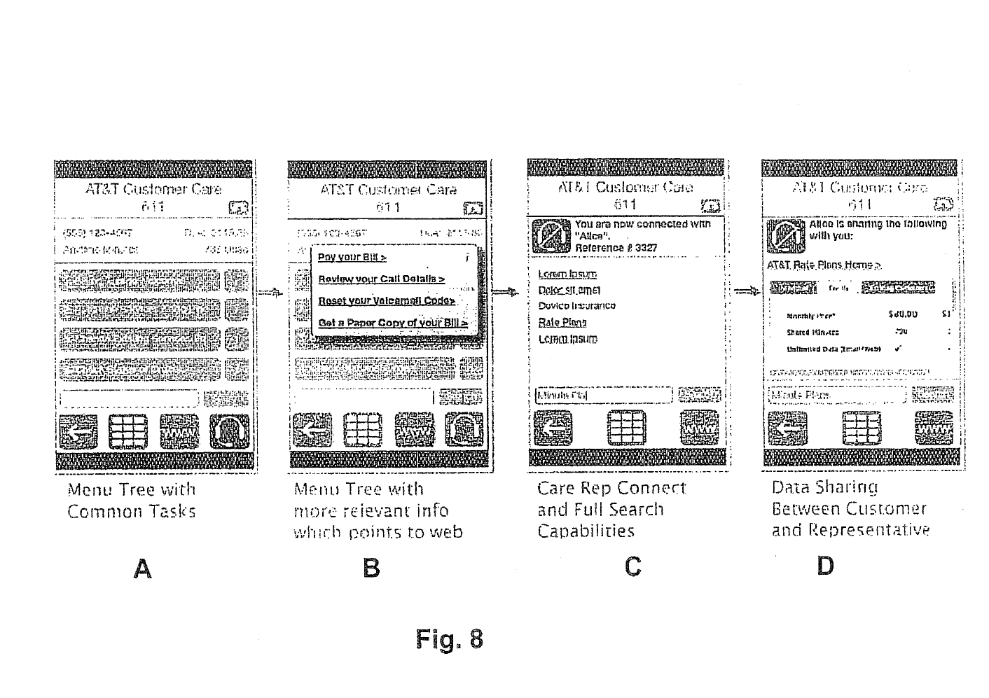

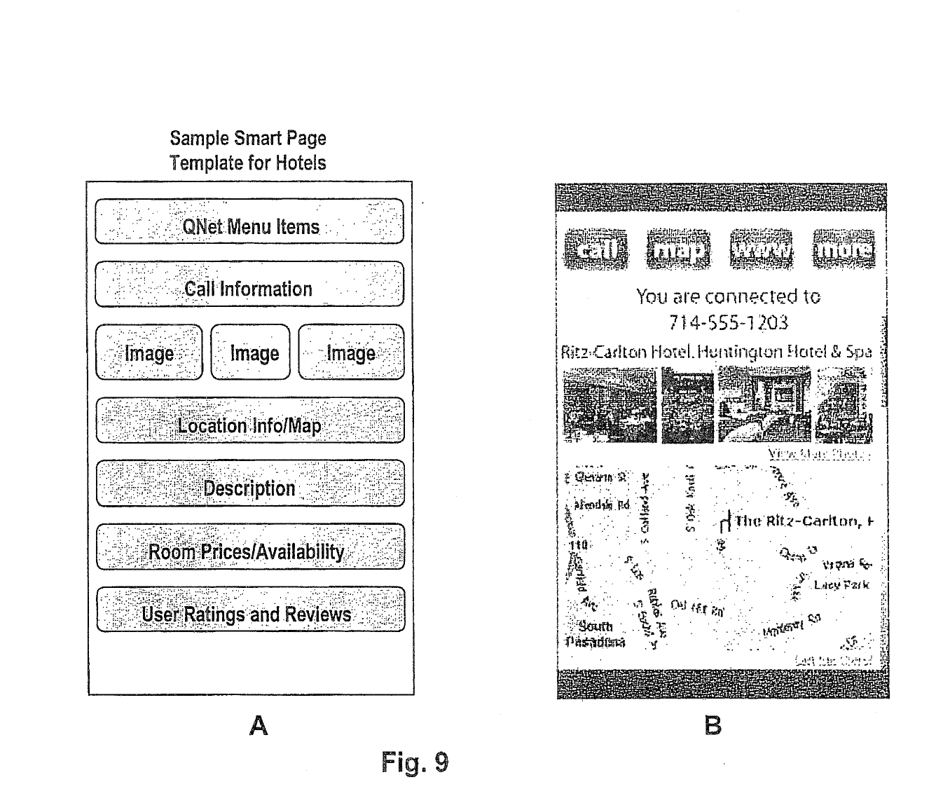

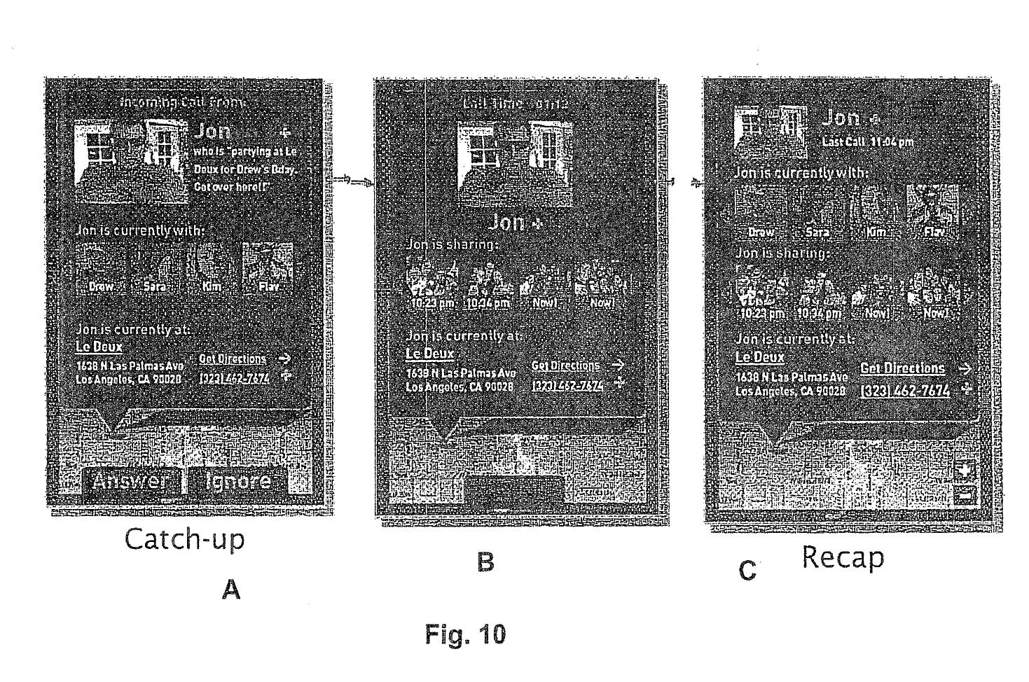

A more detailed depiction of a search string 250 is shown in FIG. 6 which depicts the search terms utilized for the “Smart” search that include, but is not limited to: an Entity (business) Name, Address and Type; a SmartResults™ template to be populated; GPS X, Y Coordinates or Current Zipcode; any Audio Capture Keywords; a User's Calendar (information about the day's meetings and events); User Preferences and Learned Preferences (i.e., calling party preferences learned over time using “implicit learning” technology which tracks usage behavior on a per-user basis, remembering which SmartResults™ web pages were viewed most frequently, and which selections were made most frequently within the SmartResults™). For instance, if the user is calling his/her favorite lunch restaurant [as learned by the QNet server], and his/her calendar shows them having a meeting at their office in the next 15 minutes, the intelligence built into the QNet server application could push a SmartResults™ page to the user prompting them if they would like to order their favorite lunch items for pick-up or delivery [if available]; if the called restaurant also has the system in place, the system could push the order directly to the called party to facilitate and expedite the ordering process. The search string 275 generated in connection with process steps 228 depicted in FIG. 5B depicts similar search terms utilized for the “Smart” search however, with search terms appropriate for the individual being contacted.

It is understood that, the detailed call flow scenarios depicted in FIGS. 5A and 5B may be oriented to push content from the calling mobile device to the called party whether it be a business or individual. This will be accomplished via the use of an interactive web service or other software application, depicted as “QNet Console” 198 in FIG. 1 and FIG. 2.

FIG. 7 depicts the ongoing call flow scenario 300 while an established call session is taking place (step 302) using the technology of the invention. Key to this algorithm is the functionality depicted at the QNet or like application server for performing the mapping translation based on continually received contextual information received from the calling device during the call. This information, in the example depicted in FIG. 7, may comprise an audio file, for example, that in addition to the contextual information, is translated by the QNet application into key words (step 306) to be used for generating a search string by functionality invoked in sub-processes (step 308). As can be seen the flow is similar as to the C2B (Consumer to Business) scenario depicted in FIG. 5A however, the search string 350 created differs. This call flow scenario highlights the fact that contextual filtering information can continue to be pushed or obtained during the call.

As mentioned, such SmartResults™ for a communication device may include visual web-based information and content including relevant, context-based information regarding a called and/or calling party. For instance, this web-based downloadable SmartResults™ web page content is adaptive and may be provided to the client device according to the needs of the calling party, e.g., Bi-directional sharing of visual information while on social voice calls (Social networking); “411” information with multi-media content provided for user visualization at the mobile device, enhanced Interactive Voice Response (IVR) systems that can provide visual rendering of IVR menu and agent/user interaction of visual information. Thus for instance, such smart content downloaded to a calling party's mobile device may include a Menu Representation of IVR thus providing a user a parallel experience for Customer Care by presenting additional features to enhance the experience.

FIG. 8 depicts example IVR SmartResults™ 400A-400D generated by the system at the client device 15, particularly the incorporation of the Menu Representation of IVR with the provision of a parallel experience for customer care by the presentation of additional features to enhance the experience. As shown in FIGS. 8A-8D, via the IVR implementation of SmartResults™, a user is provided with a full range of interactive capabilities including: Interacting with IVR system in full GUI comprising enhanced SmartResults™ additions; Accessing additional features such as common tasks associated with Menu Item, e.g., via a SmartResults™ interface 400B as enhanced with interactive SmartResults™ additions 402; Connecting and visually interacting with a customer care representative including data sharing between the customer and representative, e.g., via SmartResults™ interfaces 400C/400D enhanced with interactive SmartResults™ additions 403/404; and, access web content for additional support. For the IVR implementation of SmartResults™, the associated SmartResults™ template comprises a mix of manually created additions such as the SmartResults™ additions as illustrated in FIG. 8 on top of existing IVR menu trees.

FIG. 9B depicts an example SmartResults™ interface 450 generated by the system for display at the client device, in a “411” (information) system implementation of the invention. As shown in FIG. 9B, the “411” the example implementation of SmartResults™ 450 is provided in response to a 411 inquiry of a hotel (e.g., Ritz Carlton hotel) and provides additional SmartResults™ web page enhancements including more than just a number and an address. Whether dialing the business directly or via 411, the results are much more informative and powerful than a URL as a URL is not necessarily unique to a business, but a phone number is unique to each location and business. Moreover, users can get results that are relevant to them based on context information such as location, time, personal information such as shown in FIG. 9B. The Smart Web page 450 such as depicted in FIG. 9B that is downloaded to the mobile device browser provides enhanced additional information including interactive (user selectable) menu choices 454 for the user to navigate to and receive enhanced information such as video/photographic image information 456 regarding the hotel, and a street map 458, all generated at the back-end application server. An example SmartResults™ template used for generating the SmartResults™ page for the example call (a Ritz hotel 411 SmartResults™ inquiry) shown in FIG. 9B is shown in FIG. 9A. In FIG. 9A, the SmartResults™ page template 475 is similar across the board for IVR and P2P call scenarios however, it is understood that each page template varies depending on subject matter/category. For the Ritz Carlton hotel 411 inquiry example of FIG. 9A, the dialed digits translation and QNet server processing will retrieve the SmartResults™ template associated with a “hotel” business type such as the SmartResults™ template 475 used in the generation of the SmartResults™ web page 450 of FIG. 9B, including fields for populating the SmartResults™ web page with the following: menu items, call information, one or more images of the hotel, location information and/or map description of the hotel and room availability and rates, and, including user reviews or ratings.

FIGS. 10A-10C depicts example system interfaces 500A-500C, respectively, that are downloaded by the system for receipt and display at the mobile client device in an example “Social networking” or P2P system implementation. As depicted in FIGS. 10A-10C, users will receive SmartResults™ web pages enhanced with information and menu choices for enabling a user to catch-up on the Who, What, Where, When, and Why with an individual (resolved based on the called party number) in three types of call segments shown in FIGS. 10A-10C. For example, a SmartResults™ including “Conversation aids” 502 may be downloaded to the client such as shown in FIG. 10B in a Reference call segment and, in a Recap call segment shown in FIG. 10C, SmartResults™ web pages enables users to reflect on past conversations and Collect necessary information. For the SmartResults™ scenario shown in FIGS. 10A-10C, the dialed digits translation and QNet server processing will retrieve the SmartResults™ template associated with a resolved “individual” name and the SmartResults™ template used in the generation of the SmartResults™ 500A-500C of FIG. 10 can include fields for populating the SmartResults™ web page with the following: call information, context information, images and photos, information such as current location and/or map description of the individual's whereabouts. Thus, further enhanced content provided to said communication device about said contact includes one or more of: call information, context information, images and photos, information such as a current location, a map description of the individual's location, a user's friend(s) and information regarding the user's friends such as location, relevant software applications (such as a mobile Instant Messaging, or a Mobile Payment application), relevant advertisements, feeds, blogs, URLs, calendar, user's company/enterprise information, etc.

In an alternate embodiment, “pre-loaded” client mobile devices may include a “Smart Filtering” function implementing mechanisms for voice recognition, location, presence, and context awareness which may be part of an implicit learning feature, as described above. Moreover, types of “SmartResults™” may be stored or cached as a library of per-enterprise-type page templates (e.g., restaurants, coffee shops, hotels, retail shops by type (clothing, books, electronics, etc.)) designed based on usage. Implicit learning may be applied to templates as can a Machine-to-machine/semantic web for dynamic page creation.

Additional features and other implementations of the invention include, but are not limited to:Use of VoIP, with a session control protocol such as SIP client implementations over varying internet connection technologies; and, use of Mobile devices' implementation of:
VoIP/SIP implementation in broadband cellular networks including 3G networks such as HSDPA and EVDO, as well as 4G networks such as WiMax, and LTE,
WiFi Internet+cellular voice implementation.
Simultaneous voice and data channel establishment in HSDPA and EVDO Rev A networks.

Although the embodiments of the present invention have been described in detail, it should be understood that various changes, substitutions and alternations can be made therein without departing from spirit and scope of the inventions as defined by the appended claims. Variations described for the present invention can be realized in any combination desirable for each particular application. Thus particular limitations, and/or embodiment enhancements described herein, which may have particular advantages to a particular application need not be used for all applications. Also, not all limitations need be implemented in methods, systems and/or apparatus including one or more concepts of the present invention.

The present invention can be realized in hardware, software, or a combination of hardware and software. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

What is claimed is:

1. A system for providing enhanced content to a communication device comprising:
means for establishing a communications session for enabling a communication session between a calling party using said communication device and a called party over a communication path via a communications network, said call session established with said called party utilizing a phone number associated with said called party; and,
server means in association with said communications network for receiving dialed digits associated with said called party phone number and generating a data structure associated with said phone number, said data structure including a search criteria used to enhance information content about said called party to be provided to said communication device;
a searching means for initiating a web-based search for enhanced information content according to said search criteria provided by said data structure;
means responsive to said call for generating a web page including said enhanced content and communicating said web page including said enhanced content to said communication device, and,
browser means, at said mobile device, responsive to receipt of said web page including said enhanced content for rendering said web page for said calling party,
whereby relevant information about said called party is dynamically provided to a calling party's communication device whether or not a voice communication between said parties is occurring or not over said communications path.

2. The system as claimed in claim 1, wherein a communication device includes an agent function for providing contextual information associated with a current context of said communication device, and initiating communication of said contextual information to said server means associated with said communications network at the time said call session is established.

3. The system as claimed in claim 2, wherein said generated data structure includes a search criteria including one or more key words associated with said current context of said communication device.

4. The system as claimed in claim 3, wherein said generated contextual information includes context information associated with a current calling party, said generated data structure includes a search criteria including one or more key words associated with a context of said calling party.

5. The system as claimed in claim 1, wherein said server means comprises:
means for assembling said data structure based upon a pre-determined template, said template used to enable population of search criteria terms for said data structure.

6. The system as claimed in claim 1, wherein said called party is a business, said system further including:
means for translating said phone number of said called party into a business name and business address, said means further associating said business name and business address into a business type;
means for selecting a pre-determined template used to assemble said data structure based upon said business type.

7. The system as claimed in claim 6, wherein said enhanced content provided to said communication device includes an enhanced Graphical User Interface including menu-based selections for enabling a calling party to interact with, share data with or provide data to said business or receive and view images therefrom.

8. The system as claimed in claim 6, wherein said enhanced content provided to said communication device includes 3^{rd} party advertisements.

9. The system as claimed in claim 6, wherein said communication device is a mobile device, said enhanced content provided to said mobile device including mobile applications.

10. The system as claimed in claim 6, wherein said means for communicating said web page enables pushing said enhanced content to said communication device in response to a received phone call from said mobile device.

11. The system as claimed in claim 2, wherein said agent function enables pushing, during an established communications session, dynamically generated information from said communication device to said server means for access by a called party.

12. The system as claimed in claim 1, wherein said called party is an individual, said system further including:
means for translating said phone number of said called party into a contact name, said means further associating said contact name into a social status;
means for selecting a pre-determined template used to assemble said data structure based upon said social status of said contact.

13. The system as claimed in claim 12, wherein said enhanced content provided to said communication device about said contact includes one or more of: call information, context information, images and photos, information such as a current location, a map description of the individual's location, user's friends and information regarding the user's friends such as location, a relevant software application, advertisements, feeds, blogs, URLs, calendar, a user's company/enterprise information.

14. The system as claimed in claim 1, wherein said search criteria includes one or more of: a business Name, Address and Type; a template to be populated; mobile device GPS Coordinates, a current zip code, Audio Capture Keywords, information about a calling party's current meetings and events, calling party preferences and calling party preferences learned over time.

15. A method for providing enhanced content to a communications device comprising:
establishing a communications session between a calling party using said communications device and a called party over a communications path via a communications network, said call session established with said called party utilizing a phone number associated with said called party; and,
providing, to a server device in association with said communications network, said called party phone number and generating a data structure associated with said phone number, said data structure including a search criteria used to enhance information content about said called party to be provided to said communications device;
initiating, via a search tool, a web-based search for enhanced information content according to said search criteria provided by said data structure;
generating, in response to said call, a web page including said enhanced content;
communicating said web page including said enhanced content to said communications device, and,
rendering, by a browser means at said communication device, said web page for said calling party including said enhanced content,
whereby relevant information about said called party is dynamically provided to a calling party's communication device either while a voice communication is occurring or not over said communications path.

16. The method as claimed in claim 15, further comprising: implementing, by said communication device, an agent for generating contextual information associated with a current context of said mobile device, and initiating communication of said contextual information to said server means associated with said communications network at the time said call session is established.

17. The method as claimed in claim 16, wherein said generated data structure includes a search criteria including one or more key words associated with said current context of said communication device.

18. The method as claimed in claim 17, wherein said contextual information generated includes context information associated with a current calling party, said generated data structure includes a search criteria including one or more key words associated with a context of said calling party.

19. The method as claimed in claim 15, wherein said server device comprises:
assembling said data structure based upon a pre-determined template, and populating said data structure with search criteria terms based on said template.

20. The method as claimed in claim 15, wherein said called party is a business, said method further including:
translating said phone number of said called party into a business name and business address, and associating said business name and business address into a business type; and,
selecting a pre-determined template used to assemble said data structure based upon said business type.

21. The method as claimed in claim 20, wherein said enhanced content provided to said mobile device includes enhanced Graphical User Interface including menu-based interactive selections for enabling a calling party to interact with, share data with or provide data to said business or receive and view images therefrom.

22. The method as claimed in claim 20, wherein said enhanced content provided to said communication device includes 3^{rd} party advertisements.

23. The method as claimed in claim 22, wherein said communication device is a mobile device, said enhanced content provided to said mobile device including mobile applications.

24. The method as claimed in claim 20, further comprising: pushing said enhanced content to said communication device in response to a received phone call from said communication device.

25. The method as claimed in claim 15, further comprising: pushing, during an established communications session, dynamically generated information from said communication device to said server means for access by a called party.

26. The method as claimed in claim 15, wherein said called party is an individual, said method further including:
translating said phone number of said called party into a contact name, and further associating said contact name into a social status; and,
selecting a pre-determined template used to assemble said data structure based upon said social status of said contact.

27. The method as claimed in claim 26, wherein said enhanced content provided to said communication device about said contact includes one or more of: call information, context information, images and photos, information such as a current location, a map description of the individual's location, a user's friends and information regarding the user's friends such as location, a relevant software application, advertisements, feeds, blogs, URLs, calendar, a user's company/enterprise information.

28. The method as claimed in claim 15, wherein said search criteria includes one or more of: a business Name, Address and Type; a template to be populated; mobile device GPS Coordinates, a current zip code, Audio Capture Keywords, information about a calling party's current meetings and events, calling party preferences and calling party preferences learned over time.

29. A program storage device readable by a machine, tangibly embodying a program of instructions executable by the machine to perform method steps for providing enhanced content to a communication device while said communication device is communicating over an established communications path via a communications network, said method steps comprising:
providing, to a server device in association with said communications network, dialed digits associated with a called party phone number and generating a data structure associated with said phone number, said data structure including a search criteria used to enhance information content about said called party to be provided to said communications device;
initiating, via a search tool, a web-based search for enhanced information content according to said search criteria provided by said data structure;
generating, in response to said call, a web page including said enhanced content; and,
communicating said web page including said enhanced content to said communications device,
whereby a browser means at said communications device renders said web page for said calling party including said enhanced content either while a voice communication is occurring or not over said established communications path.

30. A method of deploying a computer program product for providing enhanced content to a communication device while said communication device is communicating over a communications path established via a communications network with a called party device, wherein, when executed, the computer program performs the steps of:
providing, to a server device in association with said communications network, dialed digits associated with a called party phone number and generating a data structure associated with said phone number, said data structure including a search criteria used to enhance information content about said called party to be provided to said communication device;
initiating, via a search tool, a web-based search for enhanced information content according to said search criteria provided by said data structure;
generating, in response to said call, a web page including said enhanced content; and,
communicating said web page including said enhanced content to said communication device,
whereby a browser means at said communication device renders said web page for said calling party including said enhanced content either while a voice communication is occurring or not over said established communications path.
